(19) United States
(12) Patent Application Publication
(10) Pub. No.: US 2026/0133796 A1
(43) Pub. Date: May 14, 2026

(54) TESTING AND VALIDATION OF FUNCTIONS IN A CLOUD-BASED 5G MOBILE TELEPHONE NETWORK

(71) Applicant: DISH Wireless L.L.C., Englewood, CO (US)

(72) Inventors: Brian Peletz, Aurora, CO (US); Steven Wilson, Englewood, CO (US); Prakash Srinivasan, Englewood, CO (US); Kevin Plunkett, Englewood, CO (US)

(73) Assignee: DISH Wireless L.L.C., Englewood, CO (US)

(21) Appl. No.: 19/032,372

(22) Filed: Jan. 20, 2025

Related U.S. Application Data
(60) Provisional application No. 63/623,137, filed on Jan. 19, 2024.

(51) Int. Cl. G06F 8/75; H04L 41/14

(52) U.S. Cl. CPC G06F 8/75; H04L 41/14

(57) ABSTRACT

Computing systems, devices and automated processes are described for automatically testing or validating new functions prior to deployment in a cloud-based telecommunications system, such as a 5G wireless network. The new function is initially received within a sandbox environment that is isolated from production systems and that permits the function to be evaluated upon such factors as scalability, statelessness, container-based nature, resiliency, observability and/or any other factors as desired. The automated processing evaluates the new function to ensure at least a threshold level of compliance with each factor. Passing functions may be permitted to be stored in a code base or otherwise deployed for further testing and/or production environments to implement an operation of the 5G wireless network, as appropriate, while non-passing functions may be flagged for further development.

### PRIORITY CLAIM

This application claims the benefit of U.S. Provisional Application No. 63/623,137 filed on Jan. 19, 2024 and entitled, “TESTING AND VALIDATION OF FUNCTIONS IN A CLOUD-BASED 5G MOBILE TELEPHONE NETWORK,” which is incorporated herein by reference.

### TECHNICAL FIELD

The following generally relates to wireless data networks, such as 5G wireless networks. More particularly, the following relates to systems, devices and automated processes to test and/or validate functions used to implement a wireless data network in a cloud-based computing environment.

### BACKGROUND

Wireless networks that transport digital data and telephone calls are becoming increasingly sophisticated. Currently, fifth generation (“5G”) broadband cellular networks are being deployed around the world. These 5G networks use emerging technologies to support data and voice communications with millions, if not billions, of mobile phones, computers and other devices. 5G technologies are capable of supplying much greater bandwidth than was previously available, so it is likely that the widespread deployment of 5G networks could radically expand the number of services available to customers.

Traditionally, data and telephone networks relied upon proprietary designs based upon very specialized hardware and dedicated point-to-point data connections. More recently, industry standards such as the Open Radio Access Network (“Open RAN” or “O-RAN”) standard have been developed to describe interactions between the network and various client devices. The O-RAN model follows a virtualized wireless architecture in which 5G base stations (“gNBs”) are implemented using separate centralized units (CUs), distributed units (DUs) and radio units (RUs), along with various control planes that provide additional network functions (e.g., 5G Core, IMS, OSS/BSS/IT). Generally speaking, it is still necessary to implement the RUs with physical transmitters, antennas and other hardware located onsite within broadcast range of the end user's device.

Other components of the network, however, can be implemented using a more centralized architecture based upon cloud-based computing resources, such as those available from Amazon Web Services (AWS) or the like. This provides much better network management, scalability, reliability and redundancy, as well as other benefits. O-RAN CUs, DUs, control planes and/or other components of the network can now be implemented as software modules executed by distributed (e.g., “cloud”) computing hardware. Other network functions such as access control, message routing, security, billing and the like can similarly be implemented using centralized cloud computing resources. Often, a CU, DU, control plane or other image is created in software for execution by one or more virtual computers operating in parallel within the cloud environment. The many virtual servers can be very rapidly scaled to increase or decrease the available computing capacity as needed.

The use of virtualized hardware provides numerous benefits in terms of rapid deployment and scalability, but it also presents certain technical challenges that have not been encountered in more traditional wireless networks. Unlike traditional wireless networks that scaled through the addition of physical routers, switches and other hardware, RAN networks can scale upwardly and downwardly very quickly as new cloud-based services are deployed and/or existing services are retired or redeployed. Additional network components can be very quickly deployed, for example, through the use of virtual components executing in a cloud environment that can be very quickly duplicated and spawned as needed to support increased demand. Similarly, virtual components can be de-commissioned very quickly with very little cost or effort when network capacity allows. The virtual components provide substantial efficiencies, especially when compared to prior networks that were based upon complex interconnections between geographically dispersed routers, servers and the like.

One technical challenge that arises in the new networks, however, involves the development, testing and validating new functions before they are deployed. Due to the massively inter-related nature of the 5G network system, it is very important that newly designed functions be able to seamlessly integrate with other operations of the network. It is also desirable that the newly-designed functions be evaluated to make sure that they meet various criteria for reliability, scalability and the like.

Software testing has existed in various forms for some time. But the unique technical challenges of a large telecommunications network deployed in a cloud environment create a particular need for specialized testing processes and systems. A substantial desire therefore exists to build systems, devices and automated processes that allow for testing and validation of functions in cloud-based 5G wireless networks prior to deployment. These and other features are described in increasing detail below.

### BRIEF SUMMARY

According to various embodiments, systems and automated processes provide for automated testing and validation of functions prior to deployment in a cloud-based telecommunications system, such as a 5G wireless network. Each new function is initially received within a sandbox computing environment that permits the function to be evaluated upon such factors as scalability, statelessness, container-based nature, resiliency, observability and/or any other factors as desired. The automated processing evaluates the new function to ensure at least a threshold level of compliance with each factor. Passing functions may be permitted to be deployed in further testing and/or production environments, as appropriate, while non-passing functions may be flagged for further development.

In one example embodiment, a cloud-based data processing system that implements a 5G wireless network suitably comprises: a plurality of components systems that collectively implement the 5G wireless network, wherein each of the component systems executes one or more of a plurality of functions; a sandbox processing system that initially receives a new function for inclusion in the plurality of functions, wherein the sandbox processing module performs an automatic evaluation of the new function to ensure that the new function is container based and cloud native, wherein the automatic evaluation comprises: evaluating scalability of the new function to determine a scalability metric; evaluating the new function to determine a container based metric; evaluating statelessness of the new function to determine a stateless metric; comparing each of the scalability metric, the container based metric and the stateless metric to a threshold value associated with that metric; and if any of the scalability, container based and statelessness metrics do not pass the associated threshold value, then rejecting the new function, and otherwise passing the new function to thereby permit the new function to operate within the 5G wireless network. Other embodiments could consider a subset of these factors, and/or could consider additional or other factors as appropriate.

Other embodiments provide a sandbox processing system comprising a processor and a non-transitory digital storage to evaluate a new function for inclusion within a database comprising a plurality of functions that collectively implement a 5G wireless network using cloud-based processing resources. The non-transitory storage comprises computer-executable instructions that, when executed by the processor, perform an automated process. The automated process suitably comprises: receiving a new function for inclusion in the plurality of functions; evaluating scalability of the new function to determine a scalability metric; evaluating the new function to determine a container based metric; evaluating statelessness of the new function to determine a stateless metric; comparing each of the scalability metric, the container based metric and the stateless metric to a threshold value associated with that metric; and if any of the scalability, container based and statelessness metrics do not pass the associated threshold value, then rejecting the new function, and otherwise passing the new function to the database to thereby permit the new function to perform an operation of the 5G wireless network.

Other embodiments provide data processing systems, devices and/or automated processes to automatically test and/or validate functions operating within a cloud data processing system, such as the data processing system used to implement a wireless 5G network. These and other example embodiments are described in increasing detail below.

### DRAWING FIGURES

FIG. 1 shows an example of a cloud-based wireless network system having integrated testing/validation capabilities.

FIG. 2 illustrates one example of a sandbox data processing system for automatically testing new functions in a cloud-based telecommunications system.

FIG. 3 is a flowchart showing one example of an automated process to be performed by a sandbox or other data processing system to automatically test new functions in a cloud-based telecommunications system.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, a centralized testing/validation system suitably includes automated processing for evaluating newly-received program functions prior to deployment in a 5G or similar wireless network. Functions are automatically evaluated to ensure that the function is appropriately container-based and cloud native based upon such criteria as scalability, statelessness, container-based design, resiliency, observability and/or any other factors as desired. Evaluation may occur within a “sandbox” computing environment such as a virtual private cloud (VPC) of a cloud-based data processing system that is logically isolated from the production VPCs used to implement the actual network, thereby permitting effective evaluation while isolating untested functions from those that have been cleared for use in the production environment.

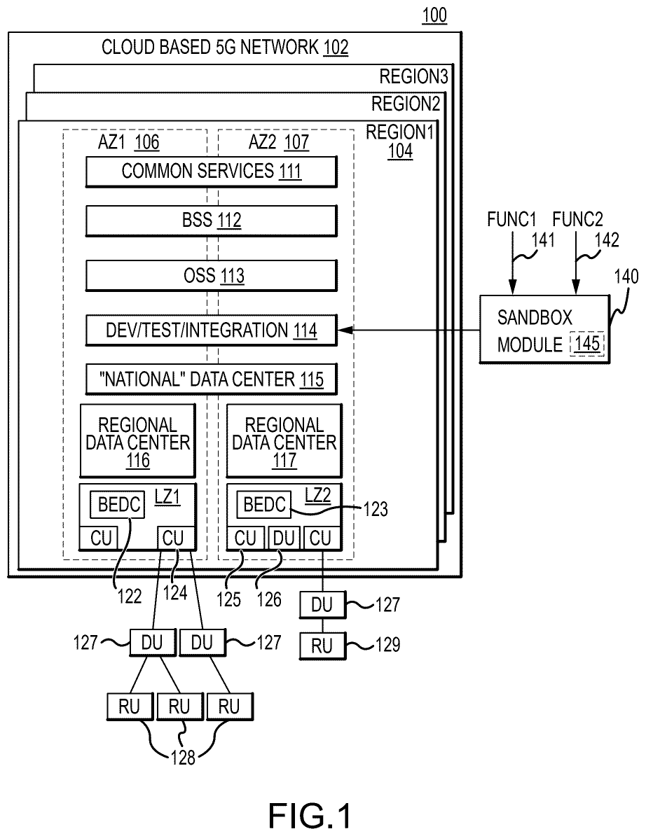

With reference to FIG. 1, a 5G wireless network 102 suitably includes development/test/integration (D/T/I) service 114 that manages a software code base that implements the 5G network 102 within a cloud based computing environment. In the examples described below, D/T/I service 114 includes a sandbox system 140 that receives new functions 141, 142 and that automatically evaluates the new functions to ensure compatibility, scalability, cloud-native functionality and other features prior to deployment of the new function within the production environment of system 102. Sandbox system 140 is described in increasing detail below, but the following discussion will provide a relevant context for deploying a sandbox system 140 that performs automated testing and evaluation of new functions within the cloud-based 5G wireless telecommunications network 102.

In contrast to most conventional networks that rely upon specialized hardware and numerous widely-distributed data centers, network 102 can be implemented using cloud-based computing resources such as those available from Amazon Web Services Inc. (AWS) of Seattle, Washington. Other cloud services are available from Microsoft Corp. of Redmond, Washington, IBM Corp. of Armonk, New York, and many others. The various functions and modules of the wireless network can be implemented within virtual private clouds (VPCs) or similar structures within the cloud computing environment. In the example of FIG. 1, network 102 encompasses virtualized data processing services supporting multiple regions 104, each having one or more availability zones (AZs) 106, 107 each acting as a separate data center with its own redundant power, network connectivity and other resources as desired. In some implementations, the various AZs operating within the same region will provide redundancy in the event that another AZ would fail, become overloaded, or otherwise become unavailable. The example of FIG. 1 illustrates three regions, with region 104 having two AZs 106, 107, although other embodiments could include any number of regions and AZs providing any number of services and resources. The regions and zones are often described herein with reference to geographic locations, but in practice the regions and zones could be equivalently organized based upon customer density, user density, expected network demand, availability of electric power and/or bandwidth, and/or any other factors. As noted above, it will generally be necessary to deploy radio units (RUs) within broadcast range of end users. By implementing the other functions of the network using virtualized hardware operating within a cloud-type architecture, however, geographic restrictions upon the network 102 can be greatly reduced. This can provide substantial efficiencies in deployment and expansion of network 102, while also allowing for more efficient use of computing resources, data storage and electric power.

In example system 100, a network operator maintains ownership of one or more radio units (RUs) 128, 129 associated with a wireless network cell. Each RU 128, 129 suitably communicates with user equipment (UE) operating within a geographic area using one or more antennas/towers capable of transmitting and receiving messages within an assigned spectrum of electromagnetic bandwidth. In various embodiments, the assigned spectrum may be allocated across one or more guest networks 1 to support multiple concurrent networks, if desired.

The Open RAN standard breaks communications into three main domains: the radio unit (RU) 128, 129 that handles radio frequency (RF) and lower physical layer functions of the radio protocol stack, including beamforming; the distributed unit (DU) 127 that handles higher physical access layer, media access (MAC) layer and radio link control (RLC) functions; and the centralized unit (CU) 124, 125, 126 that performs higher level functions, including quality of service (QoS) routing and the like. CUs 124, 125, 126 may also support such features as packet data convergence protocol (PDCP), service data adaptation protocol (SDAP) and radio resource controller (RRC) functions. Examples of RU, DU and CU functions are described in more detail in the Open RAN standards, as updated from time to time, and may be modified as desired to implement the various functions and features described herein.

In the example illustrated in FIG. 1, common services (e.g., billing, guest network allocation, etc.) can be performed in a shared service 111 across the available AZs 106, 107. Typically, these shared services will be implemented within a common virtual private cloud (VPC) operating within the cloud environment. Similarly, shared VPC systems can support business support system (BSS) 112, operational support services (OSS) 113, development/test/integration features 114, and/or the like across the entire region.

As noted above, DTI service 114 appropriately includes a “sandbox” environment 140 that can be used to evaluate various functions 141, 142 prior to deployment within a production environment of system 100. To that end, sandbox environment 140 typically supports various software or firmware modules 145 for performing various automated tests on the newly-received function, as described more fully herein. Sandbox environment 140 may be implemented in a VPC or similar structure of the cloud environment. Equivalently, sandbox environment 140 could be implemented in separate processing space, including conventional computer systems using physical hardware in any location.

The example network 102 illustrated in FIG. 1 includes one or more region wide data centers (e.g., “national” data center 115 in FIG. 1) that could be implemented in a shared VPC across AZs 106, 107 for the region, if desired, with subordinate data centers (e.g., “regional” data centers 116, 117) being separated into different VPCs for each of the AZs 106, 107. The various data centers could provide any number of services such as IP multimedia services (IMS), 5G core services and/or the like. Additional levels of data centers could be provided, if desired, and/or the different data center functions could be differently organized in any number of equivalent embodiments.

Each AZ 106, 107 in FIG. 1 includes one or more breakout edge data centers (BEDCs) 122, 123 each supporting a local zone (LZ) with one or more RUs 128, 129. The BEDCs are ideally organized for very low latency and high throughput to the various user equipment operating within the local zone. BEDCs 122, 123 will typically implement one or more CUs (e.g., CUs 124 and 125-126, respectively) in accordance with the O-RAN specifications. BEDCs 122, 123 may also implement user plane functions that handle user data sessions for gaming, streaming and other network services, as desired. Again, any number of BEDCs 122, 123 and other data centers may be implemented using any number of different or shared VPCs in the cloud environment 100, as desired.

Each RU 128, 129 is typically associated with a different wireless cell that provides wireless data communications to any number of user devices operating within broadcast range of the cell. RUs 128, 129 may be implemented with radios, filters, amplifiers and other telecommunications hardware to transmit digital data streams via one or more antennas. Generally, RU hardware includes one or more processors, non-transitory data storage (e.g., a hard drive or solid state memory) and appropriate interfaces to perform the various functions described herein. RUs are physically located on-site with the transmitter/antenna, as appropriate. Conventional 5G networks may make use of any number of wireless cells spread across any geographic area, each with its own on-site RU.

User devices are often mobile phones or other portable devices that can move between different cells associated with the different RUs, although 5G networks are also widely expected to support home and office computing, industrial computing, robotics, Internet-of-Things (IoT) and many other devices. While the example illustrated in FIG. 1 shows just a few RUs 128, 129 for convenience, a practical implementation will typically have any number of RUs that can each be individually configured to provide highly configurable geographic coverage for the 5G network 102.

Distributed units (DUs) 126, 127 suitably process baseband signals, including modulation, coding, beamforming and the like for one or more RUs 128, 129. If desired, some or all of the DUs 126, 127 could support multiple RUs 128, 129 and could coordinate activities between the two RUs, if desired. DUs 127 could be located, for example, at the base of a cell tower or the like. In some embodiments, DUs 126 could be implemented in virtual hardware with a local zone (e.g., LZ2 in FIG. 1) if desired. DUs 126, 127 generally communicate with a CU 124, 125 to exchange control information and to manage resource allocation, as desired.

As noted above, the various components of network 102 can be implemented using virtual private clouds (VPC) or other virtualized hardware components executing software or firmware instructions that are stored in a non-transitory data storage (e.g., a disk drive or solid state memory) for execution by one or more processors within the VPC. The cloud environment provides the opportunity to scale processing, data storage and bandwidth resources on an as-needed basis, thereby providing substantial efficiencies in comparison to previous network systems that relied upon specialized hardware spread across a large geographic area. VPCs may provide any number of additional features to support the data handling functions of system 102, including redundancy, scalability, backup, key management and/or the like.

The various functions that implement the components of system 102 may be created and managed in any manner. In one example, D/T/I system 114 manages a database or other repository of code that has been tested and found to be allowed within the production network 102. Before entering the repository of allowed code, new software functions are evaluated based upon various factors. While previous implementations often relied upon manual review by a human operator and/or rudimentary code analysis, an automated validation can provide much more effective and efficient review, thereby providing a more robust and secure software implementation. To that end, it can be very desirable to provide an automated analysis that can evaluate new functions, and that can verify that the new function is suitably container-based and cloud native prior to deployment in production systems.

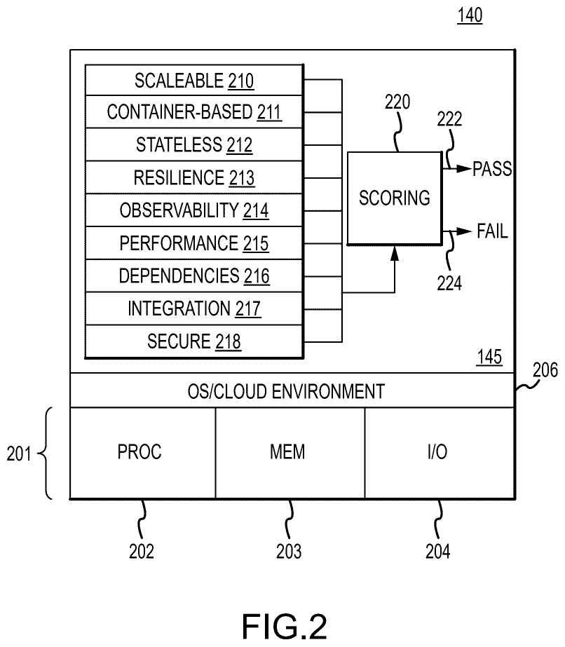

FIG. 2 shows one example of a sandbox system 140 that could be implemented within D/T/I system 114 of wireless network 102, or in any other manner. With reference to FIG. 2, sandbox system 140 suitably executes software or firmware instructions 145 to perform automated analyses 210-218 of a newly received function 141, 142. The function 141, 142 is evaluated based upon various factors, and if it passes the evaluations, then the function can be passed for use in system 102 as desired. Alternatively, if the function 141, 142 does not pass one or more of the evaluations, the function can be prevented from use in the production system 102. Various embodiments can provide a report of the analysis results so that the function 141, 142 can be modified, repaired or otherwise improved.

Sandbox system 140 can be implemented using any available hardware 201, such as any sort of processor 202, solid state or other non-transitory data storage 203 and appropriate input/output interfaces 204. As noted above, sandbox system 140 could be implemented on a personal computer, server or similar hardware with conventional processing, storage and interface capabilities. In other embodiments, sandbox system 140 could be implemented using cloud-based hardware, such as one or more virtual private clouds (VPCs) associated with the Amazon Web Services (AWS) system, or any other cloud service as desired. In this case, an abstraction layer 206 provides operating system and similar capabilities to permit software 145 to execute and perform the desired functions using cloud-based hardware 201, as appropriate. Again, other cloud services other than AWS could be used, if desired.

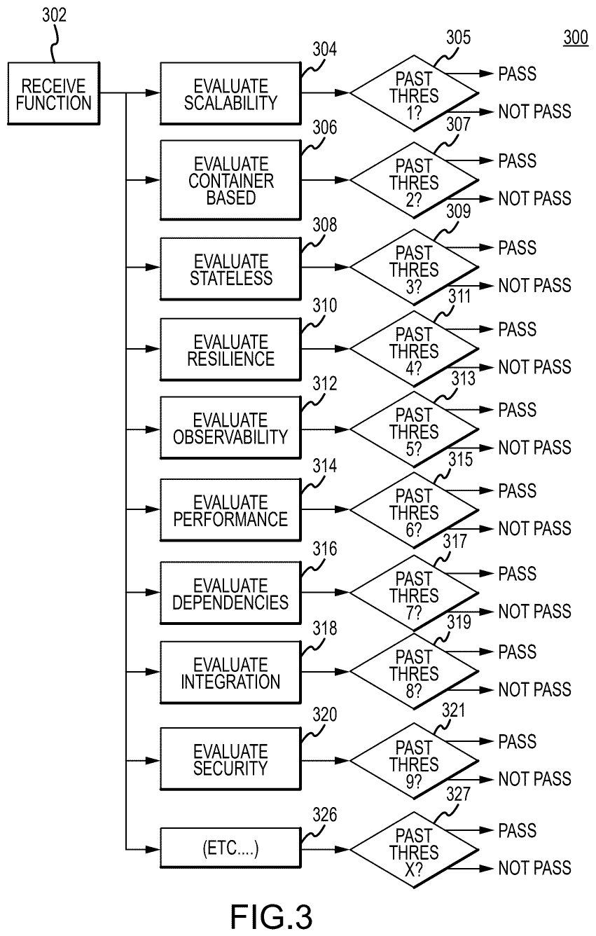

In the example of FIG. 2, various sub-systems 210-218 provide automated analysis to evaluate a received function 141, 142 on such factors as scalability (function 210), container-based nature (function 211), statelessness (function 212), resilience (function 213), observability (function 214), performance (function 215), dependencies (function 216), integration (function 217), security (function 218), and any others as desired. Results of each analysis are provided to a scoring function 220 that suitably determines whether the function is passed 222 or failed/non passed 224 in any manner. As described more fully below, various embodiments provide numerical ratings in each analysis sub-system 210-218 that can be compared to one or more threshold values. If the evaluation score is sufficient in comparison to the threshold value for that metric, then the function 141, 142 can be passed with regard to that metric. Although FIG. 2 shows nine subsystems 210-218 corresponding to nine different factors, other embodiments could combine the various factors in other ways, could omit one or more factors, and/or may consider other factors in addition to or in place of the factors shown in the figures. To that end, equivalent embodiments could be constructed that consider any number of factors in addition to or in place of the specific factors listed in the example of FIG. 2-3.

Functions 141, 142 under test may be evaluated in series or in parallel, as desired. In a series evaluation, the various tests 210-218 are performed in sequence so that function 141, 142 is evaluated for subsequent factors only if it passes the previous tests. In a parallel analysis, the new function 141, 142 may be stored so that multiple copies of the function can be simultaneously evaluated. Serial and parallel analysis can also be combined, if desired, so that some tests are performed first, with additional testing only performed if the initial tests are successful. If one or more analyses 210-218 are particularly computationally demanding, for example, it may be beneficial to delay performing that test until the function 141, 142 has been confirmed to pass other tests, to provide just one example.

The various evaluations 210-218 may be performed in any manner. FIG. 3 shows one example 300 of an automated process in which the various evaluations 210-218 are performed in parallel, with the results of the evaluations being compared to appropriate threshold values to determine whether or not the function 141, 142 passes the evaluation. As noted above, each of the various functions shown in FIG. 3 could be performed using programmed software or firmware instructions that are stored in storage 203 for execution by processor 202, as appropriate.

In the example of FIG. 3, one or more new functions 141, 142 to be tested are initially received 302 by sandbox system 140 for analysis. The functions 141, 142 may be stored in storage 203 or the like for subsequent analysis. As noted above, copies of the stored function may be used for parallel analysis of multiple factors, if desired. In various embodiments, multiple instances of the new function 141, 142 may be created for one or more analyses to verify consistency and completeness, if desired. Generally speaking, it is desirable for a new function 141, 142 to be compatible with a cloud-based environment 102 that implements the 5G wireless network. To that end, functions 141, 142 should be scalable, container-based, resilient, stateless, observable, and/or the like. Other embodiments may evaluate different factors from those shown in FIG. 3, including additional factors as desired.

Scalability of the new function 141, 142 can be evaluated in any manner (function 304). Scalability in this context refers to the ability of the new function 141, 142 to be used in multiple simultaneous instances within system 102 without breaking or causing errors. Many instances of certain functions could be simultaneously needed within the system 102, for example, so that each instance needs to be able to communicate and operate independently of the others. One factor that can restrict scalability is the use of hardcoded addresses (e.g., internet protocol (IP) addresses or uniform resource locators (URLs)). If such addresses are hardcoded into the function 141, 142, then multiple simultaneous instances of that function 141, 142 could generate undesirable simultaneous interactions with the same address, thereby potentially leading to confusion, data loss or other undesirable consequences. To that end, a check for scalability 304 could include a scan for hardcoded IP addresses, URLs or other addresses. Scalability analysis 304 could also scan for direct IP-to-IP communications between functions (as opposed to communication through the cloud environment or other mechanisms).

Any addresses or address-based communications could be tallied or otherwise accounted for, as desired, with the resulting tally compared against a threshold value (function 305) as appropriate. In some examples, an address count could be compared to a threshold value of “one” to ensure that no undesired communications are present within the function 141, 142, although other embodiments could be arranged in any other manner to make use of different thresholds. If no hardcoded addresses or address-based communications are identified in the function 141, 142, the function may be passed with regard to the scalability analysis 210. Otherwise, the function 141, 142 may not pass, with results reported for further analysis or repair, as desired.

Container-based nature (evaluation 211) can be performed in any manner (function 306). Generally speaking, the cloud system that hosts network 102 will operate based upon container-type structures all of the code for the function and its dependencies is “contained” within a single structure so that the function runs quickly and reliably from one instance to another. Evaluation 211 may also ensure compatibility with a container management tool such as Amazon Elastic Container Service (ECS), Amazon Elastic Kubernetes Service (EKS) and/or the like.

In various embodiments, container-based nature is evaluated by comparing the new function 141, 142 to a template function that has appropriate formatting for the desired environment. Further analysis can also evaluate whether the function 141, 142 includes any static configurations that can prevent recovery in the event of fault or failure. Any differences from the template, as well as any static configurations in the function 141, 142, can be tallied for comparison to a container-based threshold value 307 as desired. The threshold value 307 may be determined empirically, if desired, recognizing that some variations from the template may be permissible in certain circumstances. Other implementations may prevent any variation from the template such that even a single variation or static configuration could result in the function 141, 142 not passing evaluation 211. In some implementations, threshold 307 could vary based upon the intended use of function 141, 142 or other factors. That is, some functions 141, 142 may be less critical than others such that more variations from the template will be tolerated. Other embodiments, however, will require strict compliance before passing the function 141, 142. If the function 141, 142 is not passed, it will generally be desirable to provide a report or other output indicating the differences from the template and/or other non-compliance that led to the function 141, 142 not passing the analysis so that a human or automated programmer can repair any discrepancies.

Statelessness can also be evaluated in any manner (function 308). Statelessness generally refers to the desire for the function 141, 142 to operate without retaining any internal state or session data about a client that is using the function. This generally means that each request to the function is treated as new and independent so that the function does not rely upon information from previous interactions to respond to the current request. To that end, evaluating for statelessness 308 can involve scanning the function 141, 142 for any user or session data that is stored internal to the function, and tallying any occurrences of such data. As with previous checks, various embodiments could set a threshold value 309 to permit some data to be retained within the function 141, 142, although many implementations will not pass the function 141, 142 if even a single instance of user or session data is stored within the function. Again, results of the check may be further processed as appropriate to pass the function 141, 142 or to report the reasons for not passing the test, as desired.

Resilience 213 refers to the ability of a function 141, 142 to handle and recover from any failures or other issues that could otherwise disrupt operations. Fault tolerance is particularly important in the cloud environment due to the distributed nature of services and the inherent reliance upon remote computing resources that are not always present in legacy networks. Resilience is typically evaluated (function 310) through chaos engineering or the like that evaluates the function's ability to handle faults, crashes, high loads and/or other conditions. Generally speaking, chaos engineering involves testing the function 141, 142 to evaluate the function's ability to withstand changing and unforeseen conditions, and to minimize possible points of error or failure. It is also desirable that functions 141, 142 be fault-tolerant so that they can withstand any adverse conditions when they occur. Chaos testing may therefore be used to simulate server failures, application failures, network failures, infrastructure issues and/or other conditions as appropriate. The function's ability to withstand challenges and tolerate adverse conditions can be quantified in any manner (function 310), and compared to an appropriate threshold value 311 as desired. Again, the threshold value 311 can be set as desired to reflect the level of fault tolerance that is expected, and the types of testing that are applied.

Observability analysis 214 involves verifying that the function 141, 142 is compatible with mechanisms in system 102 to detect issues and to monitor performance of the system 102. Function 312 therefore involves verifying compliance with reporting structures (e.g., KAFKA or other reporting tools) within system 102. Testing may involve spawning a test instance of the function 141, 142 and analyzing data produced by the test instance. Testing could also involve checking syntax or other language within the function's code, as appropriate. The observability threshold 313 could be set as desired, based upon the particular analysis applied and the level of compliance that is expected. In various embodiments, observability analysis could be partially or wholly combined with the analysis 306 of container-based nature, since both may be at least partially based upon comparisons to a template function. Other embodiments could be structured in any other manner, as desired.

Performance of the function 141, 142 may be evaluated in any manner (function 314). Performance could relate to such factors as latency, throughput, data consistency and/or the like. In various embodiments, analysis 314 involves spawning one or more instances of the function 141, 142 and observing operation under simulated conditions. Multiple instances of the function could be spawned to evaluate simultaneous performance, if desired. In some examples, performance analysis 314 could be partially or wholly combined with resiliency analysis 310 so that fault tolerance and performance are both tested under the same simulated conditions, if desired. The function 141, 142 can be assigned a numeric rating based upon its performance assessment, and that rating can be compared to a threshold value 315 to determine if the function passes or not, as described above.

Dependency analysis 316 refers to any external resources that the function 141, 142 may need to operate correctly. These other resources could include libraries, external services, other functions, configuration data, data storage or other physical computing resources, and/or the like. Generally speaking, it is desirable for each function 141, 142 to minimize any such dependencies, and for any dependencies that are present to be clearly identified and documented. To that end, analysis 316 can involve comparison to a template, checking for references to external resources, and/or other factors as desired. Dependencies may be checked using the same template analysis used for container-based nature 306 and/or observability 312, if desired, or a separate analysis could be performed as shown in FIG. 3. If any dependencies are identified, certain types of dependencies may be permissible if they are clearly identified and documented, as appropriate. As with other analyses performed, dependencies may be tallied or otherwise quantified in any manner for comparison to a suitable threshold 317 to determine if the function 141, 142 passes the analysis or not.

Integration analysis 318 suitably involves verifying that the function 141, 142 is compatible with any needed databases, messaging queues, storage, data pipelines and/or other resources available to components of system 102. Integration analysis can involve syntax checks and/or comparisons to template functions, as noted above, and may therefore be combined with other analyses described herein as appropriate. Compatibility can be numerically quantified in any manner (e.g., by tallying variations from a template, or by counting language that complies with any required resources, or in any other manner). The numerical quantification can then be compared with a numerical threshold 319 to pass or not pass the function under test. Note that, depending upon the particular testing applied, the function 141, 142 may be determined to “pass” if the number of required references exceeds a threshold 319, and/or if the number of variances from a template does not exceed threshold 319. The specific threshold 319 used will therefore depend upon the type of testing applied.

Security can be evaluated in any manner (function 320). In various embodiments, security analysis 320 involves identifying vulnerabilities, ensuring proper authentication and/or authorization of users, compliance with security standards or regulatory requirements, and/or the like. Security may be evaluated using available software tools, or by checking the syntax of the code for presence or absence of certain features (e.g., references to necessary security mechanisms, no references outside of approved mechanisms). Compliance and/or variance can be quantified, as appropriate, and compared to numeric threshold 312 as desired to pass or not pass the function 141, 142 under test.

As noted at the outset, automated process 300 may involve additional or alternate analysis as desired (function 326). Any additional factors may be numerically quantified and compared to appropriate threshold values 327 to determine whether or not the function 141, 142 passes the analysis.

After the automated analyses have been applied, results can be processed in any manner. As noted above, it may be desirable that the function 141, 142 under test pass all of the evaluations prior to deployment within the production environment 102. Passing functions 141, 142 may be stored in a repository or other code base of D/T/I system 114, if desired, for deployment within system 102. Conversely, non-passing functions 141, 142 may be prevented from being deployed. Various embodiments may also provide a report of the testing results so that a human or automated programmer can make adjustments in the function's code, as desired.

Some embodiments could additionally add “tags” or other identification data to the newly-evaluated function to permit subsequent identification or filtering of the approved function. One example of a sandbox system 140 that provides a tagging operation for approved functions is described by U.S. Provisional Application No. 63/623,058 filed on Jan. 19, 2024 and entitled “AUTOMATIC FUNCTION TAGGING IN A CLOUD-BASED 5G MOBILE TELEPHONE NETWORK,” which is incorporated herein by reference, although other tagging systems and processes could be equivalently used in other embodiments.

Various embodiments therefore provide data processing systems, devices and/or automated processes to automatically test/validate new functions prior to deployment in a cloud-based telecommunications system, such as a 5G telephone network. Other embodiments may provide additional benefits and features, as desired.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A cloud-based data processing system that implements a 5G wireless network, the data processing system comprising:
a plurality of components systems that collectively implement the 5G wireless network, wherein each of the component systems executes one or more of a plurality of functions;
a sandbox processing system that initially receives a new function for inclusion in the plurality of functions, wherein the sandbox processing module performs an automatic evaluation of the new function to ensure that the new function is container based and cloud native, wherein the automatic evaluation comprises:
evaluating scalability of the new function to determine a scalability metric;
evaluating the new function to determine a container based metric;
evaluating statelessness of the new function to determine a stateless metric;
comparing each of the scalability metric, the container based metric and the stateless metric to a threshold value associated with that metric; and
if any of the scalability, container based and statelessness metrics do not pass the associated threshold value, then rejecting the new function, and otherwise passing the new function to thereby permit the new function to operate within the 5G wireless network.

2. The cloud based data processing system of claim 1, wherein the evaluating the scalability of the new function comprises identifying hardcoded internet protocol (IP) addresses in the new function.

3. The cloud based data processing system of claim 1, wherein the evaluating the scalability of the new function comprises identifying internet protocol (IP) to IP communications in the new function.

4. The cloud based data processing system of claim 3 wherein evaluating the container based metric comprises comparing the new function to a template function.

5. The cloud based data processing system of claim 4 wherein the evaluating the statelessness of the new function comprises determining whether the new function stores user or session data internal to the function.

6. The cloud based data processing system of claim 5 wherein the automatic evaluation further comprises evaluating resilience of the new function using chaos testing to determine a resilience metric.

7. The cloud based data processing system of claim 6 wherein the automatic evaluation further comprises evaluating observability of the new function to determine an observability metric, wherein the evaluating of the observability comprises determining compatibility with monitoring and logging functions of the 5G wireless network.

8. The cloud based data processing system of claim 1 wherein the data processing system comprises a non-transitory data storage configured to store the plurality of functions in a database, and wherein the function is passed from the sandbox processing system to the database for subsequent retrieval and execution by one or more of the plurality of components of the 5G wireless network.

9. A sandbox processing system comprising a processor and a non-transitory digital storage to evaluate a new function for inclusion within a database comprising a plurality of functions that collectively implement a 5G wireless network using cloud-based processing resources, wherein the non-transitory storage comprises computer-executable instructions that, when executed by the processor, perform an automated process that comprises:
receiving a new function for inclusion in the plurality of functions;
evaluating scalability of the new function to determine a scalability metric;
evaluating the new function to determine a container based metric;
evaluating statelessness of the new function to determine a stateless metric;
comparing each of the scalability metric, the container based metric and the stateless metric to a threshold value associated with that metric; and
if any of the scalability, container based and statelessness metrics do not pass the associated threshold value, then rejecting the new function, and otherwise passing the new function to the database to thereby permit the new function to perform an operation of the 5G wireless network.

10. The sandbox processing system of claim 9, wherein the evaluating the scalability of the new function comprises identifying hardcoded internet protocol (IP) addresses in the new function.

11. The sandbox processing system of claim 10, wherein the evaluating the scalability of the new function comprises identifying internet protocol (IP) to IP communications in the new function.

12. The sandbox processing system of claim 11 wherein evaluating the container based metric comprises comparing the new function to a template function, and wherein the evaluating the statelessness of the new function comprises determining whether the new function stores user or session data internal to the function.

13. The sandbox processing system of claim 9 wherein the automatic evaluation further comprises evaluating resilience of the new function using chaos testing to determine a resilience metric and evaluating observability of the new function to determine an observability metric, wherein the evaluating of the observability comprises determining compatibility with monitoring and logging functions of the 5G wireless network.

14. An automated process to be performed by a data processing system to evaluate a new function for inclusion in a database comprising a plurality of functions that collectively implement a 5G wireless network, wherein the automated process comprises:
receiving the new function for inclusion in the plurality of functions;
evaluating scalability of the new function to determine a scalability metric;
evaluating the new function to determine a container based metric;
evaluating statelessness of the new function to determine a stateless metric;
comparing each of the scalability metric, the container based metric and the stateless metric to a threshold value associated with that metric; and
if any of the scalability, container based and statelessness metrics do not pass the associated threshold value, then rejecting the new function, and otherwise passing the new function to thereby permit the new function to operate within the 5G wireless network.

15. The automated process of claim 14, wherein the evaluating the scalability of the new function comprises identifying hardcoded internet protocol (IP) addresses in the new function.

16. The automated process of claim 15, wherein the evaluating the scalability of the new function comprises identifying internet protocol (IP) to IP communications in the new function.

17. The automated process of claim 16 wherein evaluating the container based metric comprises comparing the new function to a template function, and wherein the evaluating the statelessness of the new function comprises determining whether the new function stores user or session data internal to the function.

18. The automated process of claim 17 wherein the automatic evaluation further comprises evaluating resilience of the new function using chaos testing to determine a resilience metric and evaluating observability of the new function to determine an observability metric, wherein the evaluating of the observability comprises determining compatibility with monitoring and logging functions of the 5G wireless network.

19. The automated process of claim 15 wherein the data processing system comprises one or more processors configured to perform the receiving, evaluating, comparing, rejecting and passing, and a non-transitory data storage configured to store the database comprising the plurality of functions that collectively implement a 5G wireless network.

20. The automated process of claim 19 wherein the one or more processors and non-transitory data storage are implemented within cloud-based computing machinery.
